(19) United States
(12) Patent Application Publication
(10) Pub. No.: US 2021/0203086 A1
(43) Pub. Date: Jul. 1, 2021

(54) CABLE WITH TERMINAL FORMED THEREIN AND WIRE HARNESS

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventors: Takuya YAMASHITA, Yokkaichi-shi (JP); Tetsuya NAKAMURA, Yokkaichi-shi (JP); Yoshiaki YAMANO, Yokkaichi-shi (JP); Junichi ONO, Yokkaichi-shi (JP); Takaaki ITO, Yokkaichi-shi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 16/756,895

(22) PCT Filed: Oct. 18, 2018
(86) PCT No.: PCT/JP2018/038776

§ 371 Date: Apr. 17, 2020

(30) Foreign Application Priority Data
Oct. 25, 2017 (JP) 2017-205925

(51) Int. Cl. H01R 4/18; H01R 4/70; H01B 7/28; H01R 4/62; H01B 7/00

(52) U.S. Cl. CPC H01R 4/185; H01R 4/70; H01B 7/0045; H01R 4/62; H01B 7/2806

(57) ABSTRACT

A terminal-equipped electrical wire including: a terminal fitting; an electrical wire that includes a conductor surrounded by an insulation covering and is electrically connected to the terminal fitting in an electrical connection; and a resin cover that is made of a resin material and covers the electrical connection, wherein the resin cover is in contact with the insulation covering, a tensile shear adhesion strength between the resin cover and the insulation covering is 0.7 MPa or higher, and a breaking elongation ratio of the resin cover is 30% or higher.

### BACKGROUND

The present disclosure relates to a terminal-equipped electrical wire and a wire harness, and more specifically relates to a terminal-equipped electrical wire that has a resin cover portion for corrosion prevention provided on an electrical connection portion for connecting a conductor and a terminal fitting, and to a wire harness that employs the terminal-equipped electrical wire.

In an electrical wire for being routed in a vehicle such as an automobile, a terminal fitting is connected to a conductor at the end of the electrical wire. There is desire to prevent corrosion at the electrical connection portion where the terminal fitting and the conductor of the electrical wire are electrically connected to each other. Particularly in the case where different metal materials are in contact with each other in the electrical connection portion, it is possible for dissimilar metal corrosion to occur. In order to achieve vehicle weight reduction and the like, the conductor in electrical wires for use in vehicles is sometimes made of aluminum or an aluminum alloy. However, the terminal fitting is often made of copper or a copper alloy, and also plated with tin or the like. In this case, the problem of dissimilar metal corrosion can easily occur at the electrical connection portion where the aluminum-based metal comes into contact with the copper-based material or tin plating layer. For this reason, there is desire to reliably prevent corrosion of the electrical connection portion.

Covering the electrical connection portion with a resin material is a known method for preventing corrosion of the electrical connection portion. For example, JP 2011-103266A discloses a terminal-equipped covered wire having an electrical connection portion for connecting a terminal fitting and an electrical wire conductor, and discloses that a main component of a corrosion prevention material that covers the electrical connection portion is a thermoplastic polyamide resin and has an aluminum overlap tensile shear strength, a coefficient of elongation, and a coefficient of water absorption that are in predetermined ranges.

### SUMMARY

When a terminal-equipped electrical wire is routed in a small place for example, the electrical wire is sometimes bent at the portion covered with the corrosion prevention material or in the vicinity thereof. For example, due to demand for ensuring a larger interior space, increasing complexity of electrical wiring, and the like in automobiles, sometimes terminal-equipped electrical wires need to be routed in a bent state in small spaces.

In the case of a terminal-equipped electrical wire in which the electrical connection portion of the terminal-equipped electrical wire is covered with a corrosion prevention material made of a resin material as in JP 2011-103266A, when the electrical wire is bent at the portion covered with the corrosion prevention material or in the vicinity thereof, stress is applied to the corrosion prevention material itself and the interface between the corrosion prevention material and the insulation covering of the electrical wire. In such a case, there is a risk that the corrosion prevention material will detach from the insulation covering of the electrical wire. If a portion of the corrosion prevention material becomes detached, a corrosion factor such as water may intrude into the electrical connection portion, thus leading to corrosion of the electrical connection portion. The corrosion prevention material used in JP 2011-103266A has a specified aluminum overlap tensile shear strength, but even if the material has a high adhesion with aluminum, it is not necessarily the case that the adhesion to the surface of the insulation covering of the electrical wire is sufficiently strong enough to prevent detachment when the electrical wire is bent.

An exemplary aspect of the disclosure provides a terminal-equipped electrical wire and a wire harness in which the electrical connection portion for connecting the terminal fitting to the electrical wire is covered by a resin cover portion, and in which detachment caused by bending of the electrical wire can be suppressed at the interface between the resin cover portion and the insulation covering of the electrical wire.

A terminal-equipped electrical wire according to the present disclosure includes: a terminal fitting; an electrical wire that includes a conductor surrounded by an insulation covering and is electrically connected to the terminal fitting in an electrical connection; and a resin cover that is made of a resin material and covers the electrical connection, wherein the resin cover is in contact with the insulation covering, a tensile shear adhesion strength between the resin cover and the insulation covering is 0.7 MPa or higher, and a breaking elongation ratio of the resin cover is 30% or higher.

Here, it is preferable that fusion has occurred at an interface between the resin cover and the insulation covering.

Also, it is preferable that the resin cover contains at least one of a polyester resin, a polycarbonate resin, and a polyolefin resin.

A wire harness according to the present disclosure has the above-described terminal-equipped electrical wire.

In the terminal-equipped electrical wire according to an above-described aspect of the disclosure, the tensile shear adhesion strength between the resin cover and the insulation covering is 0.7 MPa or higher. In this way, the resin cover has a high adhesion with the insulation covering of the electrical wire, thus making it possible to suppress detachment of the resin cover from the insulation covering caused by stress generated at the interface between the resin cover and the insulation covering when the electrical wire is bent at the portion where the insulation covering is covered by the resin cover, or bent in the vicinity thereof. Furthermore, the resin cover has a breaking elongation ratio of 30% or higher, and therefore even when the electrical wire is bent, the resin cover is likely to deform along with that bending, and the application of stress to the interface with the insulation covering is kept small. It is also possible to suppress the case where the bending is accompanied by the formation of cracks in the constituent material itself of the resin cover. According to these effects, even if the electrical wire is bent at the portion where the insulation covering of the electrical wire is covered by the resin cover or in the vicinity thereof when the terminal-equipped electrical wire is routed in a small space for example, detachment is not likely to occur at the interface between the resin cover and the insulation covering, and it is possible to suppress corrosion of the electrical connection caused by the intrusion of a corrosion factor through a portion where detachment occurred. As a result, even when the electrical wire is bent, the corrosion resistance of the resin cover is likely to be maintained over an extended period of time.

Here, if fusion has occurred at the interface between the resin cover and the insulation covering, the adhesion of the resin cover to the insulation covering is likely to increase due to the fusion. As a result, a reduction in corrosion resistance at the interface between the insulation covering and the resin cover caused by bending of the electrical wire is particularly likely to be suppressed.

Also, if the resin cover contains at least one of a polyester resin, a polycarbonate resin, and a polyolefin resin, the resin cover is likely to exhibit strong adhesion with the surface of the resin material that constitutes the insulation covering of the electrical wire, such as polyvinyl chloride or polypropylene.

The wire harness according to an aspect of the disclosure includes the terminal-equipped electrical wire according to any of the above aspects, and therefore even if the electrical wire is bent at the portion where the insulation covering of the electrical wire is covered by the resin cover or in the vicinity thereof, detachment is not likely to occur at the interface between the resin cover and the insulation covering. The corrosion resistance of the resin cover is therefore likely to be maintained for an extended period of time.

### BRIEF DESCRIPTION OF THE DRAWINGS

FIG. 1 is a perspective side view of a terminal-equipped electrical wire according to an embodiment of the present disclosure.

FIG. 2 is a perspective plan view of the terminal-equipped electrical wire.

FIGS. 3(a) and 3(b) show transmission electron microscope (TEM) images that show the interface between the material constituting a resin cover portion and the material constituting an insulation covering, where FIG. 3(a) shows an observation image at 8,000 magnification and FIG. 3(b) shows an observation image at 40,000 magnification.

FIG. 4 is a side view of a wire harness according to an embodiment of the present disclosure.

### DETAILED DESCRIPTION OF EMBODIMENTS

Embodiments of the present disclosure will be described in detail below with reference to the drawings.

### Terminal-Equipped Electrical Wire

1. Overall Configuration

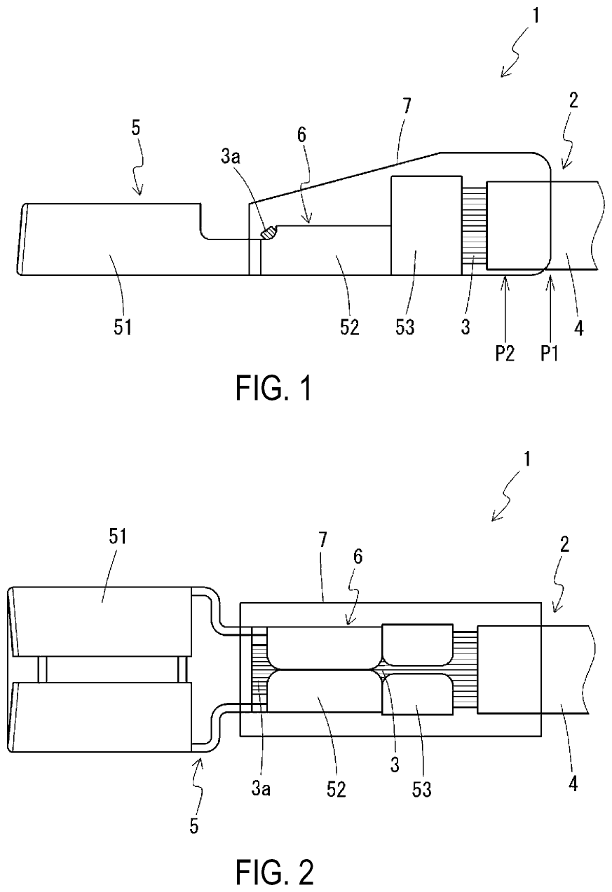

First, the overall configuration of a terminal-equipped electrical wire 1 according to an embodiment of the present disclosure will be described with reference to FIGS. 1 and 2. In the terminal-equipped electrical wire 1 according to this embodiment of the present disclosure, a conductor 3 is electrically connected to an electrical wire 2, which is covered by an insulation covering 4, and to a terminal fitting 5 by an electrical connection portion 6 (electrical connection). A resin cover portion 7 (resin cover) made of a resin material is formed so as to cover a portion that includes the electrical connection portion 6. In the present specification, with respect to the lengthwise direction of the terminal-equipped electrical wire 1, the side on which the terminal fitting 5 is arranged (the left side in FIG. 1) will be called the front side, and the side on which the electrical wire 2 is arranged (the right side in FIG. 1) will be called the rear side.

The terminal fitting 5 has a connection portion 51. A barrel portion is integrated with and extends from the rear end side of the connection portion 51, and is constituted by a first barrel portion 52 and a second barrel portion 53. The connection portion 51 is configured as a box-type fitting connection portion of a female fitting terminal, and can be fitted together with a male connection terminal (not shown).

In the electrical connection portion 6, the insulation covering 4 is removed from the end of the electrical wire 2 to expose the conductor 3. This end portion of the electrical wire 2 including the exposed conductor 3 is fixed by being crimped on one side (the upper surface side in FIG. 1) by the barrel portions 52 and 53 of the terminal fitting 5, thus connecting the electrical wire 2 and the terminal fitting 5 to each other. Specifically, the first barrel portion 52 electrically connects the conductor 3 and the terminal fitting 5, and also physically fixes the conductor 3 to the terminal fitting 5. On the other hand, at a location rearward of the first barrel portion 52, the second barrel portion 53 fixes the electrical wire 2 more weakly than the first barrel portion 52 fixes the conductor 3, thus assisting the physical fixing of the electrical wire 2 to the terminal fitting 5. Even in the case of being crimped to and fixing a rearward portion of the exposed conductor 3 at the end of the electrical wire 2, the second barrel portion 53 may fix the electrical wire 2 at a further rearward location by being crimped around the insulation covering 4 that covers the conductor 3, but in the embodiments shown in the figures, the second barrel portion 53 is crimped to and fixes the exposed conductor 3.

With respect to the lengthwise direction of the terminal-equipped electrical wire 1, the resin cover portion 7 is formed over a region that extends from a position forward of a leading end 3a of the exposed conductor 3 at the end of the electrical wire 2 to a position rearward of the leading end of the insulation covering 4 of the electrical wire 2, thus covering the entirety of the electrical connection portion 6 and a portion of the end side of the insulation covering 4 of the electrical wire 2. With respect to the circumferential direction of the terminal-equipped electrical wire 1, the resin cover portion 7 covers all of the surfaces other than the bottom surface (the lower surface in FIG. 1 on the side opposite to the side where the conductor 3 is fixed) at the position of the terminal fitting 5. At the position of the electrical wire 2, the resin cover portion 7 covers the entire circumference of the electrical wire 2.

The terminal-equipped electrical wire 1 can be used as a connector by inserting the terminal fitting 5 portion, which includes the electrical connection portion 6, into a hollow connector housing (not shown) that is made of a resin material such as polybutylene terephthalate (PBT) or the like. Not providing the resin cover portion 7 on the bottom surface of the terminal fitting 5 as described above facilitates insertion into the hollow portion of a small connector housing, but the resin cover portion 7 may be provided on the bottom surface of the terminal fitting 5 if the hollow portion is sufficiently large for example.

2. Configurations of Members

The following describes the specific configurations of the electrical wire 2, the terminal fitting 5, and the resin cover portion 7 that constitute the terminal-equipped electrical wire 1.

(1) Electrical Wire

The conductor 3 of the electrical wire 2 may be constituted by a single metal strand, but is preferably made up of a stranded wire in which multiple strands are twisted together. In this case, the stranded wire may be constituted by one type of metal strand, or may be constituted by two or more types of metal strands. Also, besides metal strands, the stranded wire may also include organic fiber strands or the like. The stranded wire may also include reinforcement wires (tension members) for reinforcing the electrical wire 2, for example.

Examples of the material making up the metal strands that constitute the conductor 3 include copper, a copper alloy, aluminum, an aluminum alloy, or a material obtained by providing various types of plating on such materials. Also, in the case where metal strands serve as reinforcement wires, examples of constituent materials include a copper alloy, titanium, tungsten, and stainless steel. Moreover, in the case where organic fivers serve as reinforcement wires, one example of the constituent material is Kevlar.

The insulation covering 4 can be made up of a material such as rubber, a polyolefin such as polypropylene (PP), a halogen polymer such as polyvinylchloride (PVC), or a thermoplastic elastomer. Such materials may be used on their own, or two or more may be used in combination with each other. Various types of additives may be added to the material constituting the insulation covering 4, as necessary. Examples of such additives include a flame retardant, a filler, and a colorant.

(2) Terminal Fitting

Examples of the material (base material) constituting the terminal fitting 5 include generally-used brass, as well as copper and various types of copper alloys. The entirety of the surface of the terminal fitting 5 or a portion thereof (e.g., contacts) may be plated with various types of metals such as tin, nickel, gold, or alloys thereof.

As described above, the conductor 3 and the terminal fitting 5 may be made up of all sorts of metal materials, but if different materials are in contact with each other in the electrical connection portion 6 (as in the case where the terminal fitting 5 is made up of a general terminal material obtained by plating a copper or copper alloy base material with tin, and the conductor 3 includes strands made up of aluminum or an aluminum alloy), corrosion in particular is likely to occur in the electrical connection portion 6 due to contact with a corrosion factor such as moisture. However, by covering the electrical connection portion 6 with the resin cover portion 7 as will be described next, it is possible to suppress such dissimilar metal corrosion.

(3) Resin Cover Portion

As previously described, the resin cover portion 7 covers a region that includes the electrical connection portion 6 and extends from the leading end 3a of the conductor 3 to part of the portion where the electrical wire 2 is covered by the insulation covering 4. In this way, the electrical connection portion 6 is surrounded and covered by the resin cover portion 7, and therefore the resin cover portion 7 can prevent a corrosion factor such as water from intruding into the electrical connection portion 6 from the outside. Accordingly, the resin cover portion 7 plays a role of preventing corrosion of the electrical connection portion 6 caused by a corrosion factor.

The resin cover portion 7 is in contact with the surface of the insulation covering 4 in the rearward portion. At the contact portion between the resin cover portion 7 and the insulation covering 4, the tensile shear adhesion strength between the resin cover portion 7 and the insulation covering 4 is 0.7 MPa or higher.

Furthermore, the resin cover portion 7 has a breaking elongation ratio (tensile elongation ratio) of 30% or higher.

Note that the tensile shear adhesion strength (hereinafter, sometimes simply called adhesion strength) can be measured by performing a tensile adhesion test at room temperature in compliance with JIS K 6850. In the present specification, the value recited as the adhesion strength is a value obtained through a phenomenon such as fusion (welding) that occurs in a process for manufacturing the resin cover portion 7 such as injection molding, and it is preferable that the shear adhesion test is also performed on a sample produced under conditions that reflect that manufacturing process. The breaking elongation ratio can be measured by performing a tension test at room temperature in compliance with JIS K 7161.

Due to the adhesion strength between the resin cover portion 7 and the insulation covering 4 being 0.7 MPa or higher, strong adhesion is achieved at the interface between the resin cover portion 7 and the insulation covering 4. Accordingly, a corrosion factor cannot easily intrude into the region covered by the resin cover portion 7 through the portion in contact with the insulation covering 4, and it is possible to suppress corrosion such as dissimilar metal corrosion in the electrical connection portion 6. As a result, high corrosion resistance is achieved by the resin cover portion 7.

Also, even if the electrical wire 2 is bent in the region where the insulation covering 4 is covered by the resin cover portion 7 or bent in the vicinity thereof, it is possible to maintain the high corrosion resistance provided by the resin cover portion 7. In the terminal-equipped electrical wire 1, if the electrical wire 2 is bent in the region where the insulation covering 4 is covered by the resin cover portion 7 or bent in the vicinity thereof, detachment stress is generated at the interface between the resin cover portion 7 and the insulation covering 4. Due to the adhesion strength between the resin cover portion 7 and the insulation covering 4 being 0.7 MPa or higher, even if stress is generated at the interface between the resin cover portion 7 and the insulation covering 4 due to bending of the electrical wire 2, detachment at the interface can be suppressed by the strong adhesion force between the resin cover portion 7 and the resin cover portion 4.

Furthermore, due to the breaking elongation ratio of the resin cover portion 7 being 30% or higher, even if the resin cover portion 7 is subjected to deformation such as bending, such deformation is likely to be absorbed by elongation of the resin cover portion 7. Accordingly, when the electrical wire 2 is bent in the portion covered by the resin cover portion 7 or in the vicinity thereof, the resin cover portion 7 is likely to bend along with bending of the electrical wire 2. As a result, stress generated by bending of the electrical wire 2 is not likely to be applied to the interface between the resin cover portion 7 and the insulation covering 4. Accordingly, even when the electrical wire 2 is bent, detachment is not likely to occur between the resin cover portion 7 and the insulation covering 4. Also, due to the resin cover portion 7 following the bending of the electrical wire 2, it is also possible to suppress the formation of cracks in the constituent material itself of the resin cover portion 7 film.

In this way, in the terminal-equipped electrical wire 1 according to the present embodiment, due to strong adhesion between the resin cover portion 7 and the insulation covering 4, and the high breaking elongation ratio of the resin cover portion 7, even if the electrical wire 2 is bent in the portion where the resin cover portion 7 is covered by the insulation covering 4 or bent in the vicinity thereof, detachment at the interface between the resin cover portion 7 and the insulation covering 4 is suppressed, and a gap that allows the intrusion of a corrosion factor is not likely to be formed. Also, the formation of a crack that allows the intrusion of a corrosion factor is also suppressed in the constituent material itself of the resin cover portion 7 film. Accordingly, even when the electrical wire 2 is bent in the portion where the insulation covering 4 is covered by the resin cover portion 7 or bent in the vicinity thereof, it is possible to maintain the corrosion resistance of the resin cover portion 7 over an extended period of time. As a result, the terminal-equipped electrical wire 1 according to the present embodiment can be favorably used in the case where the electrical wire 2 needs to be routed with a bend in the vicinity of the resin cover portion 7 in a small space such as in an automobile.

From the viewpoint of achieving the particularly effective maintenance of corrosion resistance in a bent state, it is particularly preferable that the adhesion strength between the resin cover portion 7 and the insulation covering 4 is 1.0 MPa or higher, or furthermore 1.2 MPa or higher. Also, it is particularly preferable that the breaking elongation ratio of the resin cover portion 7 is 33% or higher, or furthermore 40% or higher. The higher the adhesion strength between the resin cover portion 7 and the insulation covering 4 and the breaking elongation ratio of the resin cover portion 7 are, the more preferable it is, and there are no particular limitations on the upper limit value.

Furthermore, it is preferable that the resin cover portion 7 has a modulus of elasticity (tensile elasticity) of 30 MPa or higher, or furthermore 100 MPa or higher or 500 MPa or higher. The tensile elasticity can be evaluated in compliance with JIS K 7161. Due to the resin cover portion 7 having a high modulus of elasticity, even if the resin cover portion 7 comes into contact with an inner wall surface or the like of a connector housing when the terminal fitting 5 is inserted into the connector housing, the resin cover portion 7 is not likely to become caught on the connector housing. As a result, damage to the resin cover portion 7 and a reduction in the corrosion resistance of the resin cover portion 7 are likely to be avoided during insertion into the connector housing.

There are no particular limitations on the specific resin material that constitutes the resin cover portion 7, as long as it has the above adhesion strength and breaking elongation ratio. The resin cover portion 7 includes a high polymer material as a main component, and various types of additives may be added to the high polymer material as necessary. In order to exhibit high adhesion through high compatibility with the resin material (e.g., PP or PVC) that constitutes the insulation covering 4 of the electrical wire 2, it is preferable that the high polymer material includes at least one type of material among polyester resin, polycarbonate resin, and polyolefin resin. Among these, polyester resin and polycarbonate resin have a particularly high adhesion with the constituent material of the insulation covering 4, and therefore it is preferable that the resin cover portion 7 includes at least one of them.

Examples of polyester resins include polybutylene terephthalate (PBT) resin and polyethylene terephthalate (PET) resin, and out of these two, PBT resin is favorable. Examples of polyolefin resins include polyethylene (PE) resin and polypropylene (PP) resin, and out of these two, PP resin is favorable.

Properties of the resin cover portion 7 such as the breaking elongation ratio and the adhesion strength with insulation covering 4 can be adjusted using the type and degree of polymerization of the high polymer material that constitutes the resin cover portion 7, as well as the type and content amount of additives. Also, as will be described later, the adhesion strength of the resin cover portion 7 with respect to the insulation covering 4 can also be adjusted using conditions when forming the resin cover portion 7.

There are no particular limitations on the thickness of the resin cover portion 7, but it is preferably 0.1 mm or higher from the viewpoint of ensuring sufficient corrosion resistance. On the other hand, from the viewpoint of maintaining the flexibility of the resin cover portion 7 and allowing it to follow the bending of the electrical wire 2, the thickness is preferably 0.2 mm or lower.

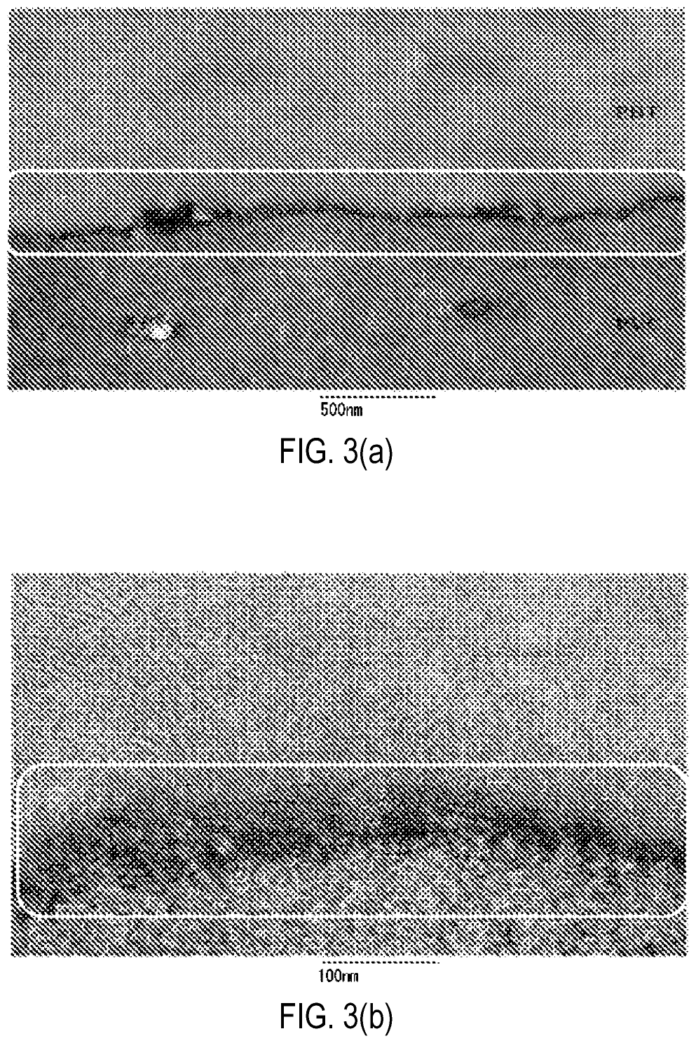

The adhesion strength between the resin cover portion 7 and the insulation covering 4 tends to rise when fusion (welding) occurs between the resin cover portion 7 and the insulation covering 4. Fusion refers to a state in which the resin material that constitutes the resin cover portion 7 and the resin material that constitutes the insulation covering 4 both melt at the interface, diffuse into each other, and then harden, and a fused layer (adhered layer) is formed at the interface of the resin cover portion 7 and the insulation covering 4 due to the mixing of the resin material with each other or a chemical reaction between them. As will be described in a following embodiment with reference to FIG. 3, the thickness of the fused layer is normally on the order of nanometers to submicrons. Also, the fused layer is likely to be formed as an interface layer that has a smooth relief structure with a relief height on the order of nanometers to submicrons. When the fused layer is formed, the resin cover portion 7 and the insulation covering 4 are strongly adhered together via the fused layer. For example, when the resin cover portion 7 is formed by injection molding or the like, the fused layer can be formed by heating the resin for forming the resin cover portion 7 to a temperature that is at or above the melting point of the insulation covering 4, and then bring it into contact with the surface of the insulation covering 4.

The specific shape of the resin cover portion 7 and the portion covered thereof are not limited to the above description, and any mode may be employed as long as the resin cover portion 7 covers at least the electrical connection portion 6 and is in contact with the insulation covering 4 of the electrical wire 2. For example, another resin material layer may be provided outward of the resin cover portion 7 for the purpose of protecting the resin cover portion 7.

Also, from the viewpoint of assisting adhesion of the resin cover portion 7 to the surface of the terminal fitting 5, a primer (adhesive) layer may be provided between the resin cover portion 7 layer and the surface of the terminal fitting 5 at the portion where the resin cover portion 7 covers the terminal fitting 5. In this case, it is preferable that the adhesion strength between the primer and the surface of the terminal fitting 5 is higher than the adhesion strength between the resin cover portion 7 and the surface of the terminal fitting 5. Also, it is preferable that the adhesion strength between the primer and the resin cover portion 7 is greater than or equal to the adhesion strength between the resin cover portion 7 and the insulation covering 4 of the electrical wire 2. Examples of the resin material used as the primer include a thermoplastic resin or a curable resin made of a thermoplastic elastomer, a polyamide resin, an acrylic resin, an epoxy resin, a urethane resin, a silicone resin, or the like.

Note that the primer is not provided between the resin cover portion 7 and the surface of the insulation covering 4, and the resin cover portion 7 is in direct contact with the surface of the insulation covering 4. In this way, the resin cover portion 7, which has a high adhesion with the insulation covering 4, is directly formed on the surface of the insulation covering 4, thus improving manufacturability and economic efficiency when manufacturing the terminal-equipped electrical wire 1.

As a method for manufacturing the terminal-equipped electrical wire 1, it is sufficient that first the barrel portions 52 and 53 of the terminal fitting 5 are crimped and fixed to the end of the electrical wire 2 where the insulation covering 4 has been peeled away. Then the resin cover portion 7 is formed, through injection molding, application, or the like, at a predetermined location on the electrical connection portion 6, which is the portion that connects the electrical wire conductor 3 and the terminal fitting 5.

The adhesion strength between the resin cover portion 7 and the insulation covering 4 can be adjusted by setting conditions when forming the resin cover portion 7. In the case where the resin cover portion 7 is formed by injection molding, it is sufficient to adjust various parameters pertaining to injection molding. For example, the adhesion strength at the interface can be increased by increasing the resin temperature, mold temperature, and holding pressure when performing injection molding.

In particular, when forming the resin cover portion 7 by introducing melted resin material to a predetermined position that includes a portion that covers the insulation covering 4, if the temperature of the melted resin material is set greater than or equal to the melting point of the polymer that constitutes the insulation covering 4, the surface layer portion of the insulation covering 4 melts due to the heat of the resin material and then hardens along with the introduced resin material, thus forming a fused layer at the interface between the insulation covering 4 and the resin cover portion 7, and achieving strong adhesion. If the melting point of the polymer that constitutes the resin cover portion 7 is higher than the melting point of the polymer that constitutes the insulation covering 4, when the resin cover portion 7 is formed, the melted resin that is hotter than the melting point of the insulation covering 4 comes into contact with the insulation covering 4 and is likely to cause the surface layer portion of the insulation covering 4 to melt, and therefore strong adhesion is likely to be achieved due to the formation of the fused layer. The higher the temperature of the melted resin material is, the higher the adhesion strength with the insulation covering 4 is, but it is preferable that the temperature is not high enough to cause thermal degeneration in the constitute materials that are to form the resin cover portion 7 and the insulation covering 4.

### Wire Harness

A wire harness according to an embodiment of the present disclosure includes multiple electrical wires, including the terminal-equipped electrical wire 1 according to the above-described embodiment of the present disclosure. All of the electrical wires included in the wire harness may be the terminal-equipped electrical wire 1 according to the above embodiment of the present disclosure, or only a portion thereof may be the terminal-equipped electrical wire 1 according to the above embodiment of the present disclosure.

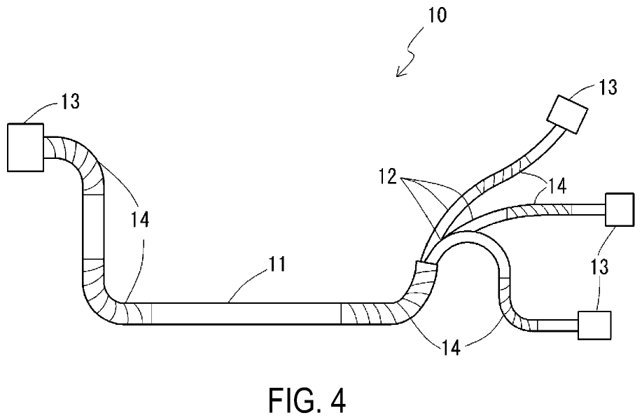

FIG. 4 shows an example of a wire harness. A wire harness 10 has a configuration in which three branch harness portions 12 branch out from the leading end portion of a main harness portion 11. Multiple terminal-equipped electrical wires are bundled together in the main harness portion 11. Those terminal-equipped electrical wires are divided into three groups, and the electrical wires in each group are bundled together in a corresponding branch harness 12. In the main harness portion 11 and the branch harness portions 12, adhesive tape 14 is used to bundle together the terminal-equipped electrical wires and hold a curved shape. The base end portion of the main harness portion 11 and the leading end portions of the branch harness portions 12 are each provided with a connector 13. The connectors 13 house terminal fittings that are attached to the ends of the terminal-equipped electrical wires.

At least one of the terminal-equipped electrical wires that constitute the wire harness 10 is the terminal-equipped electrical wire 1 according to the above embodiment of the present disclosure. The terminal fitting 5 and the electrical connection portion 6 covered by the resin cover portion 7 in that terminal-equipped electrical wire 1 are housed in a connector housing, thus constituting the connector 13.

### WORKING EXAMPLES

The following describes working examples of the present disclosure and comparative examples. Note that the present disclosure is not intended to be limited by the following working examples.

1. Evaluation of Influence of Bending on Corrosion Resistance

The relationship that the adhesion strength and the breaking elongation ratio of the resin cover portion have with the influence of bending on corrosion resistance was evaluated.

A. Materials

The following resin materials were used to form the resin cover portion.

Working Example 1: polybutylene terephthalate (PBT) resin (“C7000NY” from Polyplastics Co., Ltd.), modulus of elasticity: 900 MPa, melting point 222° C.

Working Example 2: polycarbonate (PC) resin (“H-4000” from Mitsubishi Chemical Corporation), modulus of elasticity: 2100 MPa, softening point 150° C.

Working Example 3: polypropylene (PP) resin (“MODIC” from Mitsubishi Chemical Corporation), modulus of elasticity: 1100 MPa, melting point 168° C.

Comparative Example 1: polyurethane elastomer (TPU) resin (“E580” from Nippon Miractran Co., Ltd.), modulus of elasticity: 100 MPa, melting point 130° C.

Comparative Example 2: 6-nylon (PA6) resin (“Amilan U121” from Toray Industries, Inc.), modulus of elasticity: 2600 MPa, melting point 225° C.

Comparative Example 3: liquid crystal polymer (LCP) resin (“Laperos E471i” from Polyplastics Co., Ltd.), modulus of elasticity: 14000 MPa, softening point 340° C.

B. Evaluation of Adhesion and Breaking Elongation Ratio

In order to evaluate the adhesion strength of the aforementioned resin materials with the insulation covering of the electrical wires, the resin materials were injection molded onto the surface of PVC sheets serving as models for the insulation covering. Note that the conditions used when injection molding the resin materials were set so as to match the conditions for forming the resin cover portion on the terminal-equipped electrical wires according to the working examples and the comparative examples in the later-described corrosion resistance evaluation. The adhesion strength was then evaluated for each of the produced test pieces. The adhesion strength was measured as the tensile shear adhesion strength by performing a shear adhesion test at room temperature in compliance with JIS K 6850.

Also, the resin materials were molded into sheets for evaluation of the breaking elongation ratio. This evaluation was performed by conducting a tensile test at room temperature in compliance with JIS K 7161.

C. Evaluation of Corrosion Resistance

(1) Production of Samples

First, electrical wires were produced in order to evaluate the corrosion resistance of the terminal-equipped electrical wire. Specifically, 100 parts polyvinyl chloride (degree of polymerization 1300), 40 parts diisononyl phthalate serving as a plasticizer, 20 parts calcium bicarbonate serving as a filler, and 5 parts calcium zinc-based stabilizer serving as a stabilizer were mixed at 180° C. to produce a polyvinyl chloride composition. The obtained polyvinyl chloride composition was then formed by extrusion with a thickness of 0.28 mm around a conductor (cross-sectional area of 0.75 mm) constituted by an aluminum alloy stranded wire that is made up of seven aluminum alloy wires twisted together. An electrical wire (PVC electrical wire) was thus produced.

The end of the produced electrical wire was then peeled to exposed the electrical wire conductor, and then a female press-fit terminal fitting made of tin-plated bronze, which is commonly used in automobiles, was crimped around the end of the electrical wire.

Next, terminal-equipped electrical wires according to the working examples and the comparative examples were produced. First, injection molding was performed on the electrical wires provided with the terminal fittings to form a primer layer made up of a thermoplastic elastomer (“Hytrel HTD-741H” from Du Pont-Toray Co., Ltd.) on a portion of the surface of the terminal fitting, including a portion forward of the leading end of the exposed electrical wire conductor. The above-described resin materials were then injection molded onto the primer layers to form the resin cover portions. At this time, the portions covered by the resin cover portions were the same as shown in FIGS. 1 and 2. Also, the thickness of the resin cover portions was 0.1 mm. The conditions used in injection molding (resin temperature, mold temperature, injection pressure, holding pressure, and cooling time) were set so as to obtain the adhesion strengths shown in Table 1.

(2) Post-Bending Air Leak Test

A bending test was then performed on the terminal-equipped electrical wires produced according to the working examples and the comparative examples. At this time, each terminal-equipped electrical wire was held by fixing the box-shaped connection portion (reference sign 51 in FIG. 1) of the terminal fitting. Then the electrical wire was gripped at a position rearward of the portion covered by the resin cover portion, and the gripped electrical wire was bent with a force of 200 N at a position (reference sign P2 in FIG. 1) 10 mm forward of the leading end portion of the resin cover portion (reference sign P1 in FIG. 1), in a direction corresponding to the bottom surface side of the terminal fitting 5 (downward in FIG. 1) to an angle of 90 degrees relative to the lengthwise direction. The electrical wire was then left in the bent state for three minutes.

An air leak test was then carried out on the samples subjected to the above-described bending test. Specifically, the entirety of the portion where the resin cover portion is provided on the terminal-equipped electrical wire was immersed in water, and air was applied through the end portion of the electrical wire on the side not connected to the terminal fitting, at an air pressure of 40 kPa for 10 seconds. Thereafter, the air pressure was then raised to 50 kPa for 10 seconds. In each case of air application, if the formation of air bubbles was not observed at the interface between the electrical wire covering and the resin cover portion, it was determined that detachment did not occur at the interface. If no air bubbles were formed at the interface even when the air pressure was 50 kPa, the grade “A” indicating particularly excellent corrosion resistance was determined. If air bubbles were formed at 50 kPa, but no air bubbles were formed at 40 kPa, the grade “B” indicating high corrosion resistance was determined. If air bubbles were formed even at 40 kPa, the grade “C” indicating low corrosion resistance was determined.

(3) Post-Bending Salt Water Spray Test

After the bending test, the corrosion resistance of the samples was evaluated by performing a salt water spray test in compliance with JIS Z 2371. Salt water was sprayed for 100 hours at room temperature, and then the resin cover portions were removed and the appearance of the electrical connection portions were visually observed. If corrosion products were not seen on the surface of the aluminum conductor, the grade “A” indicating high corrosion resistance was determined. If corrosion products were seen, the grade “B” indicating lower corrosion resistance was determined. The salt water spray test can be considered to be a corrosion resistance test that has stricter conditions than the above-described air leak test, and it is sometimes possible to detect even a slight reduction in corrosion resistance that cannot be detected using the air leak test.

D. Test Results

Table 1 below shows the results of measuring the adhesion strength with PVC and the breaking elongation ratio of the constituent resin materials of the resin cover portions. The table also shows the evaluation results obtained in the air leak test and the salt water spray test performed as corrosion resistance tests after the bending test.

TABLE 1

| | | Working | Working | Working | Comp. | Comp. | Comp. |
|---|---|---|---|---|---|---|---|
| | | Example | Example | Example | Example | Example | Example |
| | | 1 | 2 | 3 | 1 | 2 | 3 |
| Adhesion strength [MPa] | | 1.2 | 1.3 | 0.8 | 0.1 | 2.0 | 0.1 |
| Breaking elongation ratio [%] | | 35 | 42 | 33 | 300 | 10 | 8 |
| Post-bending | Air leak | A | A | B | B | C | C |
| corrosion | Salt water | A | A | A | B | B | B |
| resistance | spray | | | | | | |
| test | | | | | | | |

According to Table 1, in each of the working examples, the adhesion strength of the resin cover portion with the insulation covering of the electrical wire was 0.7 MPa or higher, and the breaking elongation ratio of the resin cover portion was 30% or higher, and furthermore, when subjected to the corrosion resistance tests after the bending test, high corrosion resistance was observed in both the air leak test and the salt water spray test. This indicates that because the resin cover portions had a high adhesion strength and breaking elongation ratio, detachment was not likely to occur at the interface with the insulation covering of the electrical wire. Among these working examples, in Working Examples 1 and 2 that had a particularly high adhesion strength and breaking elongation ratio, particularly excellent corrosion resistance was observed in the air leak test. Furthermore, the results of the salt water spray test in the working examples show that not only did detachment not occur at the interface between the resin cover portion and the insulation covering, but also cracks were not formed in the constituent material itself of the resin cover portion due to bending.

On the other hand, in the comparative examples, the resin cover portion was missing at least either an adhesion strength of 0.7 MPa or higher or an breaking elongation ratio of 30% or higher. Accordingly, low corrosion resistance was found in at least the salt water spray test performed after bending. This indicates that due to at least either the adhesion strength of the resin cover portion with the insulation covering or the breaking elongation ratio of the resin cover portion being insufficient, after bending of the electrical wire, detachment occurred at the interface of the insulation covering and the resin cover portion, and gaps that allowed the formation of air bubbles or the intrusion of salt water were formed. In order to maintain sufficient corrosion resistance after bending, the resin cover portion needs to have both an adhesion strength of 0.7 MPa or higher with respect to the insulation covering, and an breaking elongation ratio of 30% or higher.

In particular, in Comparative Example 1, the resin cover portion had an extremely high breaking elongation ratio of 300%, and a high corrosion resistance result was obtained in the air leak test, but the adhesion strength with insulation covering was low at 0.1 MPa, and therefore a low corrosion resistance result was obtained in the salt water spray test, which is a corrosion resistance test that has stricter conditions. In Comparative Examples 2 and 3, the breaking elongation ratio was too low, and therefore not only did detachment occur at the interface between the resin cover portion and the insulation covering of the electrical wire, but also cracks formed in the constituent material itself of the resin cover portion, and a low corrosion resistance result was obtained in both the air leak test and the salt water spray test performed after bending.

2. Observation of Interface State

Next, the state of the interface between the resin cover portion and the insulation covering of the electrical wire was examined through cross-sectional surface microscopy.

A. Production of Sample

The same PBT resin as that used in Working Example 1 in the above-described corrosion resistance tests was injection molded onto the surface of a PVC sheet, as a material that corresponds to the adhesive portion between the resin cover portion and the insulation covering of the electrical wire. The conditions used during injection molding were a resin temperature of 250 to 260° C., a mold temperature of 40 to 60° C., an injection pressure of 20 to 100 MPa, a holding pressure of 10 MPa or higher, and a cooling time of 5 seconds or higher. Note that these injection molding conditions corresponds to those in Working Example 1 in the above-described corrosion resistance tests.

B. Microscopy

A thin cross-section sample was obtained from the sample produced as described above, and the thin sample was observed using a transmission electron microscope (TEM). At this time, the acceleration voltage was 100 kV. The magnification factors were 8,000 and 40,000.

C. Observation Results

FIG. 3 shows TEM images of the PVC/PBT interface. Here, (a) is an 8,000 magnification image, and (b) is a 40,000 magnification image. The relatively bright gray layer on the upper side of the images corresponds to PBT, and the relatively dark gray layer on the lower side corresponds to PVC. As shown by the portion surrounded by a white line in the images, a layer that is darker than the PBT layer and the PVC layer, has a thickness of 100 nm or less, and has a smooth relief structure was observed at the interface between the PVC and the PBT. It can be construed that this layer is a fused layer that is formed by the PBT and the PVC both melting and diffusing into each other, and then hardening. Also, it can be understood that the layer fused with the PVC layer and the layer fused with the PBT layer are in tight contact with each other, and that strong adhesion is achieved at the interface between the PVC and the PBT via the fused layers.

3. Evaluation of Relationship Between Resin Cover Portion Formation Conditions and Adhesion Strength

The relationship that the adhesion strength of the resin cover portion with the insulation covering of the electrical wire has with the conditions used when forming the resin cover portion was evaluated.

A. Production of Samples

The same PBT resin as that used in Working Example 1 in the above-described corrosion resistance tests was injection molded onto the surface of PVC sheets to produce samples. When performing this injection molding, multiple samples were produced by changing the conditions regarding the resin temperature, the mold temperature, the holding pressure, and the adhesion strength, as shown in Table 2. For all of the samples, the injection pressure was 120 MPa, and the cooling time was 10 seconds. Also, the thickness of the PBT layer was 2.0 mm.

B. Measurement of Adhesion Strength

Similarly to the adhesion test described above, the tensile shear adhesion strength of the produced samples was measured by performing a shear adhesion test at room temperature in compliance with JIS K 6850.

C. Test Results

Table 2 below shows PBT resin molding conditions and the measured adhesion strengths.

TABLE 2

| | Condition | Condition | Condition | Condition | Condition | Condition | Condition |
|---|---|---|---|---|---|---|---|
| | 1 | 2 | 3 | 4 | 5 | 6 | 7 |
| Resin | 240 | 250 | 260 | 250 | 250 | 250 | 250 |
| temperature [° C.] | | | | | | | |
| Mold | 40 | 40 | 40 | 30 | 50 | 40 | 40 |
| temperature [° C.] | | | | | | | |
| Holding pressure | 10 | 10 | 10 | 10 | 10 | 0 | 5 |
| [MPa] | | | | | | | |
| Adhesion | 1.0 | 1.2 | 1.6 | 0.5 | 1.2 | 0.0 | 0.7 |
| strength | | | | | | | |
| [MPa] | | | | | | | |

According to Table 2, even when using the same resin material, the adhesion strength changes a large amount according to the conditions used in injection molding. The resin temperature is different in Conditions 1 to 3, and the higher the resin temperature is, the higher the adhesion strength is. This is thought to be because the higher the resin temperature is, the more easily the fused layer is formed at the interface with the PVC by the heat of the melted PBT. However, in Condition 3, it is seen that the resin temperature was too high, and therefore degradation occurred in the resin cover portion, and it is preferable that the resin temperature is kept around 250° C. as in condition 2.

The mold temperature was different in Conditions 2, 4, and 5. When the mold temperature was increased from 30° C. in Condition 4 to 40° C. in Condition 2, the adhesion strength increased. This is construed to be because the mold temperature is sufficiently high, and the injected PBT reaches the surface of the PVC while maintaining a sufficiently hot state, thus making it possible to form the fused layer. However, even if the mold temperature is further raised to 50° C. in Condition 5, the adhesion strength does not improve. This is thought to be because the effect of allowing the PBT to reach the PVC surface while remaining hot has reached a saturation point.

The holding pressure is different in Conditions 2, 6, and 7, and the higher the holding pressure is, the higher the adhesion strength is. This is thought to be because the higher the holding pressure is, the hardening of the resin material advances while the PBT is pressed against the PVC with a higher pressure, and the higher the adhesion is at the interface. In condition 6 in which no holding pressure was applied, there was substantially no adhesion between the PBT and the PVC.

It can be seen from the above-described results that the adhesion strength at the interface between the resin cover portion and the insulation covering of the electrical wire can be widely controlled with use of conditions used when forming the resin cover portion by injection molding. Among the various conditions employed in this test, it can be said that Condition 2 is the most preferable from the viewpoint of allowing the resin cover portion to strongly adhere to the insulation covering of the electrical wire while also preventing degeneration in the constituent materials. Condition 2 corresponds to Working Example 1 in the above-described corrosion resistance test and the sample formation conditions in the above-described microscopy.

Although embodiments of the present disclosure have been described in detail above, the present disclosure is not intended to be limited in any way to the above embodiments, and various changes can be made without departing from the gist of the present disclosure.

1. A terminal-equipped electrical wire comprising:
a terminal fitting;
an electrical wire that includes a conductor surrounded by an insulation covering and is electrically connected to the terminal fitting in an electrical connection; and
a resin cover that is made of a resin material and covers the electrical connection,
wherein the resin cover is in contact with the insulation covering, a tensile shear adhesion strength between the resin cover and the insulation covering is 0.7 MPa or higher, and a breaking elongation ratio of the resin cover is 30% or higher.

2. The terminal-equipped electrical wire according to claim 1,
wherein fusion has occurred at an interface between the resin cover and the insulation covering.

3. The terminal-equipped electrical wire according to claim 1,
wherein the resin cover contains at least one of a polyester resin, a polycarbonate resin, and a polyolefin resin.

4. A wire harness including the terminal-equipped electrical wire according to claim 1.
